(19) United States
(12) Patent Application Publication
(10) Pub. No.: US 2009/0257059 A1
(43) Pub. Date: Oct. 15, 2009

(54) Alignment apparatus

(76) Inventor: Iain Peter McGuffie, Stoke Lacy (GB)

Correspondence Address: Law Office Of;IRA S. Dorman, 330 Roberts Street, Suite 200, East Hartford, CT, 06108, US

(21) Appl. No.: 11/991,294

(22) PCT Filed: Sep. 5, 2006
(86) PCT No.: PCT/GB2006/003262

§ 371 Date: Feb. 29, 2008

(30) Foreign Application Priority Data
Sep. 6, 2005 (GB) 0518096.3

(51) Int. Cl. G01B 11/26

(52) U.S. Cl. 356/399

(57) ABSTRACT

An alignment apparatus includes first and second alignment devices (1) and means (9) for mounting each of the first and second alignment devices in spaced relationship one behind the other and such that one alignment device is at a higher level than the other alignment device. Each alignment device (1) includes a plate member having a surface comprising at least one area of reflective material and at least one area (3, 5) of non-reflective material. The areas of reflective material and of non-reflective material are configured such that, when an elongate beam of electromagnetic radiation is incident on both of the first and second alignment devices, the pattern of reflected radiation varies according to whether both of the first and second alignment devices are aligned with the beam.

This invention relates to an alignment apparatus which may be used, for example, for determining a direction along which to mark a line.

When marking lines, for example on sports pitches and other surfaces, it is generally considered to be ideal to mark the adjoining lines of a rectangular pitch at 90 degrees to each other. However, it is not unusual for sports pitches to be marked somewhat inaccurately and, more particularly where sports pitches are provided with a plurality of goal or like posts along a line, for the line joining the goal or like posts not to be coincident with the ideal line to be marked. In these circumstances, for aesthetic and playing reasons it is often preferable to mark along the line joining the goal or like posts rather than to mark the ideal line.

It is therefore an object of the present invention to provide an apparatus which overcomes or at least ameliorates the above problems and which, for example, facilitates marking a line coincident with a line joining goal or like posts positioned on a surface to be marked.

According to the present invention there is provided an alignment apparatus comprising first and second alignment devices and means for mounting each of the first and second alignment devices in spaced relationship one behind the other and such that one alignment device is at a higher level than the other alignment device, each alignment device including a plate member having a surface comprising at least one area of reflective material and at least one area of non-reflective material, the areas of reflective material and of non-reflective material being configured such that, when an elongate beam of electromagnetic radiation is incident on both of the first and second alignment devices, the pattern of reflected radiation varies according to whether both of the first and second alignment devices are aligned with the beam.

By “elongate beam” there is meant herein a beam of radiation which extends in a direction perpendicular to its direction of propagation.

The areas of reflective material and non-reflective material may comprise two spaced strips of non-reflective material on a base of reflective material, the strips being adapted to extend in a direction substantially parallel to the elongate direction of the beam of electromagnetic radiation.

The width of the strips may be greater than the spacing therebetween.

The strips may extend only part of the height of the respective alignment device.

The areas of reflective material and non-reflective material may include a single strip of non-reflective material extending in the longitudinal direction of the two spaced strips and offset in the longitudinal direction thereof, the single strip being collinear with the axis of the two spaced strips.

The single strip may have a width substantially the same as the spacing between the two strips.

The areas of reflective material and of non-reflective material may be provided with a shield to exclude undesired incident radiation, such as sunlight. The shield may comprise a plurality of panels hingedly connected to the remainder of the first and second alignment devices.

The mounting means may include a substantially V-shaped member for abutting against a support for the respective attachment device. Alternatively, the mounting means may include a substantially cylindrical hollow member of flexible material, the substantially cylindrical hollow member having an axial slit for engaging around a support for the respective attachment device. The mounting means may include a strap for securing the respective attachment device to a support therefor.

The first and second alignment devices may each include a spacer member for determining the spacing of the respective alignment device relative to an abutment, such as the ground, the spacer member for the first alignment device having a different length to that of the second alignment device.

Alternatively, the mounting means may include a substantially cylindrical member for engaging in a support. The length of the substantially cylindrical member for the first alignment device may be different to the length of the substantially cylindrical member for the second alignment device.

For a better understanding of the present invention and to show more clearly how it may be carried into effect reference will now be made, by way of example, to the accompanying drawings in which:

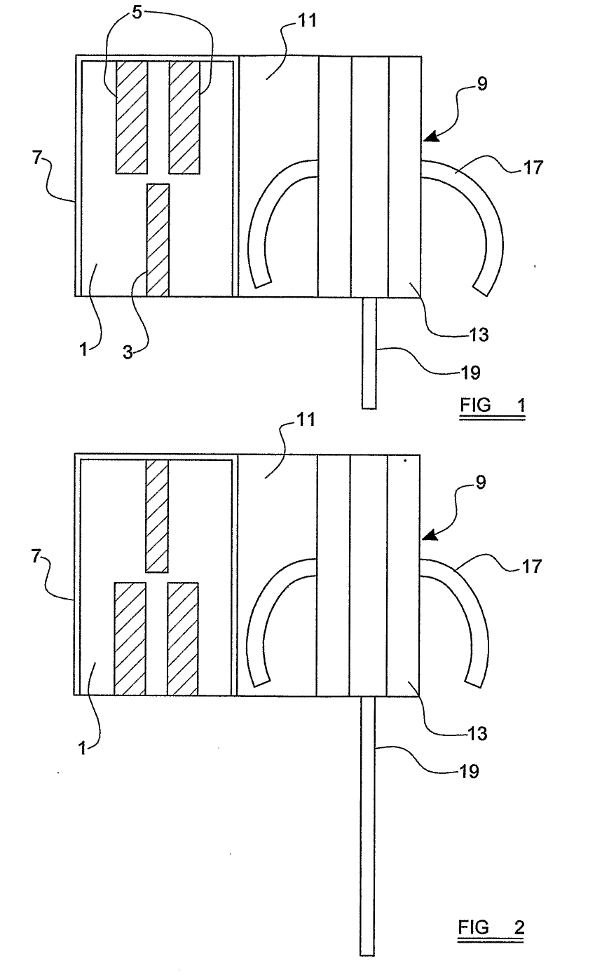

FIG. 1 is a front elevational view of an embodiment of a first alignment device forming part of the apparatus of the present invention;

FIG. 2 is a plan view of the device shown in FIG. 1;

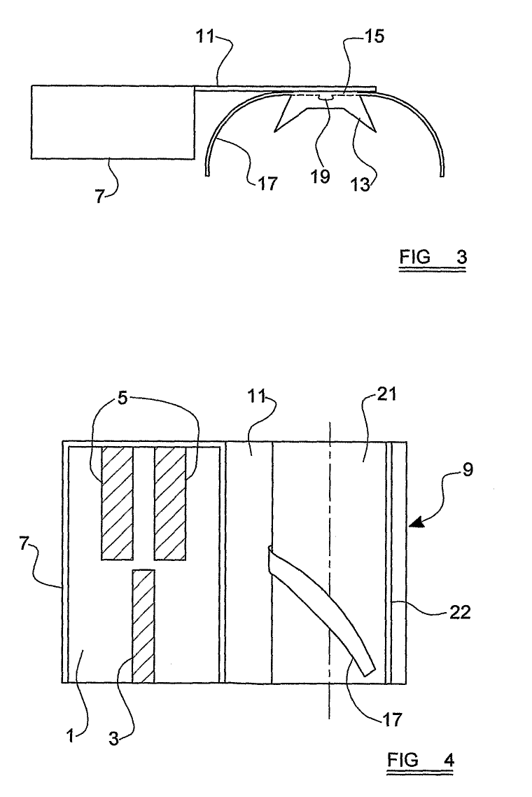

FIG. 3 is a front elevational view of an embodiment of a second alignment device forming part of the apparatus of the present invention;

FIG. 4 is a front elevational view of an embodiment of an alignment device forming part of another embodiment of an apparatus according to the present invention; and

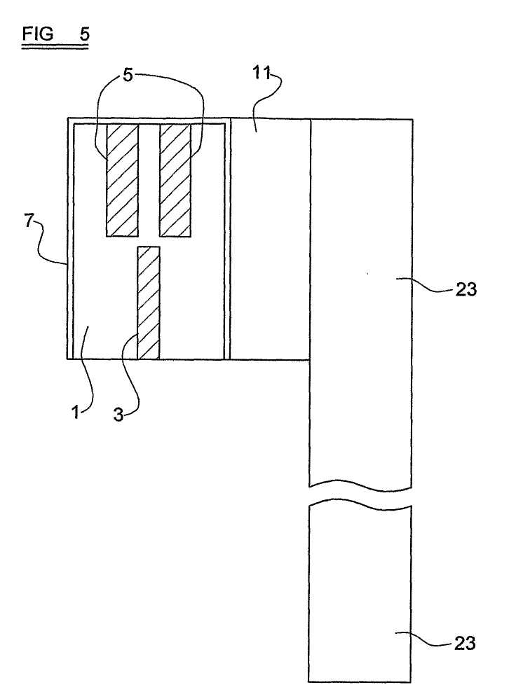

FIG. 5 is a front elevational view of a further embodiment of an alignment device forming part of a further embodiment of an apparatus according to the present invention.

A first alignment device shown in FIGS. 1 and 2 comprises a sheet 1 of suitable material such as card or metal, for example aluminium, which is provided with a reflecting surface. Provided on the reflective surface are a number of non-reflecting, for example black, marks. As illustrated, the marks are in the form of a lower upright strip 3 of predetermined width and extending substantially midway up the reflective surface, and two upper upright strips 5 of predetermined width, for example somewhat wider than the lower strip 3 and spaced laterally by a distance corresponding substantially to the width of the lower strip 3. The height of the upper strips is such that the strips extend substantially midway down the reflective surface. It may be desirable for there to be a small gap between the upper end of the lower strip 3 and the lower ends of the upper strips 5.

The reflective surface of the sheet 1 is provided with a hood 7 which extends at right angles from the reflective surface so as to shade the reflective surface from undesired incident light, such as sunlight. The hood 7 is provided around the sides and upper edge of the reflective surface, but may additionally be provided around the lower edge if desired. The hood may be made of the same material as the sheet 1 and may be in the form of a number of separate panels hingedly secured to the sheet 1 to allow the panels to fold flat for transportation and storage.

Provided along one side of the sheet 1 is a mounting assembly 9 for mounting the alignment device to a goal post or the like. The mounting assembly includes a spacer 11 and a V-shaped abutment component 13. The V-shaped component 13, although not essential, provides two lines of contact with a goal post of circular or elliptical cross-section and therefore results in greater stability that a single line of contact (for example from a planar mounting sheet) would provide. The spacer 11 spaces the sheet 1 a predetermined distance from the goal post or the like and one or more upright slots 15 are formed between the spacer 11 and the V-shaped component 13 to receive a strip 17 (see FIG. 2) of hook and loop material, such as that sold under the Registered Trade Mark VELCRO. The strip 17 of hook and loop material is passed around the goal post or the like and serves to secure the sheet 1 against the goal post in a manner which permits a temporary, but firm, attachment combined with the ability quickly to mount the alignment device to the goal post and subsequently quickly to demount the alignment device from the goal post.

A spacer member 19 extends from the lower edge of the sheet 1 to enable a user readily to determine the desired elevation of the sheet 1 above ground level. If desired, the lower end of the spacer member 19 may be provided with a sheet (not shown) to prevent the spacer member sinking into the ground.

A second alignment device is shown in FIG. 3 (the plan view being the same as FIG. 2) and the same references are used to denote the same or similar components.

The second alignment device differs from the first alignment device in that the single and double marking strips are interchanged with the single strip 3 being above the double strips 5. Additionally, the spacer member 19 is longer than the spacer member of the first alignment device in order that the height of the sheet 1 of the second alignment device should in use be at a level slightly above the first alignment device.

The first and second alignment devices are intended for use with a beam of electromagnetic radiation, such as from a laser, which is substantially aligned in the horizontally direction, but which has a slight fan, for example in the range from 0.5 to 1.5 degrees, in the vertical direction. Consequently, when aimed at the sheets of the first and second alignment devices the beam will appear as a vertical line.

In use of the first and second alignment devices, the devices are secured to two spaced posts, such as two goal posts, with the mounting assemblies providing lateral alignment and the spacer members providing vertical alignment with the second alignment device appearing at a level above the first alignment device. It is not important which of the first and second alignment devices is mounted on which of the goal posts.

The laser or the like is employed to indicate a line which is coincident with, or in practice parallel to, a line joining the two goal posts. The line to be marked can be determined by following the laser beam and marking a line at a predetermined offset relative to the laser beam.

The laser beam is aligned in two stages. In a first stage the position of the laser transmitter is adjusted until the transmitter is precisely aligned with the first and second alignment devices. This is achieved by viewing the alignment devices through a telescope mounted on the laser transmitter and moving the laser transmitter laterally until the corresponding marks on the two alignment devices are in line. In practice, it is only necessary to ensure the pairs of strips 5 are aligned.

In a second stage the angle of the laser transmitter is adjusted in a horizontal plane until the fan of laser light is visible on both the first and second alignment devices. If the position adjustment of the first stage has been carried out correctly, it is possible to align the fan of laser light simultaneously with the marks on each of the first and second alignment devices. The arrangement of the non-reflecting marks on a reflecting background are particularly helpful in that the laser light is reflected strongly from the reflecting background and from the reflecting strip between the two non-reflecting marks 5. Consequently, when the fan of laser light falls on the strip between the two marks the intensity of reflected radiation is much greater than if the laser light falls on the non-reflecting marks. The single strips 3 work in the opposite sense in that above and below the double strips 5 the reflected radiation will suddenly decrease when the laser fan is correctly aligned.

The strips 3 and 5, particularly the single strips 3 at the upper and lower ends of the two alignment devices can be employed to indicate whether the laser fan is oriented in a vertical plane or is at an angle to the vertical. The location and intensity of reflected radiation will differ between the first and second alignment devices if the laser fan is not aligned in a vertical plane and this difference can be used to re-align the laser transmitter to ensure the fan is in a vertical plane.

The first and second alignment devices can be mounted relative to the goal posts, or relative to the goal post sockets, in other ways if desired. For example, as shown in FIG. 4, the sheet 1 may be secured to a goal post by means of a generally cylindrical member 21 of resilient material which is formed with a slit 22 in the axial direction to enable the alignment device to be mounted to and demounted from the goal post. If desired, a securing strap, for example of hook and loop material, can be employed and in such a case the cylindrical member need only be of flexible material. The second alignment device is substantially the same as the illustrated device except for the arrangement of the marks on the reflective surface and an optional spacer to determine the height of the alignment device above the ground.

As a further alternative as shown in FIG. 5, in the absence of goal posts the sheet 1 can be mounted on a substantially cylindrical support member 23 which is inserted into a goal post socket. If desired, the substantially cylindrical support member 23 may be tapered so as to fit securely in a range of goal post sockets. The second alignment device is substantially the same as the illustrated device except for the arrangement of the marks on the reflective surface and the height of the cylindrical support member.

1. An alignment apparatus comprising first and second alignment devices (1) and means (9) for mounting each of the first and second alignment devices in spaced relationship one behind the other and such that one alignment device is at a higher level than the other alignment device, each alignment device (1) including a plate member having a surface comprising at least one area of reflective material and at least one area (3, 5) of non-reflective material, the areas of reflective material and of non-reflective material being configured such that, when an elongate beam of electromagnetic radiation is incident on both of the first and second alignment devices, the pattern of reflected radiation varies according to whether both of the first and second alignment devices are aligned with the beam.

2. An apparatus as claimed in claim 1, wherein the areas of reflective material and non-reflective material (3, 5) comprise two spaced strips (5) of non-reflective material on a base of reflective material, the strips being adapted to extend in a direction substantially parallel to the elongate direction of the beam of electromagnetic radiation.

3. An apparatus as claimed in claim 2, wherein the width of the strips (5) is greater than the spacing therebetween.

4. An apparatus as claimed in claim 2, wherein the strips (3, 5) extend only part of the height of the respective alignment device (1).

5. An apparatus as claimed in claim 2, wherein the areas of reflective material and non-reflective material include a single strip (3) of non-reflective material extending in the longitudinal direction of the two spaced strips (5) and offset in the longitudinal direction thereof, the single strip being collinear with the axis of the two spaced strips.

6. An apparatus as claimed in claim 5, wherein the single strip (3) has a width substantially the same as the spacing between the two strips (5).

7. An apparatus as claimed in claim 1, wherein the areas of reflective material and of non-reflective material are provided with a shield (7) to exclude undesired incident radiation.

8. An apparatus as claimed in claim 7, wherein the shield (7) comprises a plurality of panels hingedly connected to the remainder of the first and second alignment devices (1).

9. An apparatus as claimed in claim 1, wherein the mounting means (9) includes a substantially V-shaped member (13) for abutting against a support for the respective attachment device (1).

10. An apparatus as claimed in claim 1, wherein the mounting means (9) includes a substantially cylindrical hollow member (21) of flexible material, the substantially cylindrical hollow member having an axial slit (22) for engaging around a support for the respective attachment device (1).

11. An apparatus as claimed in claim 1, wherein the mounting means (9) includes a strap (17) for securing the respective attachment device (1) to a support therefor.

12. An apparatus as claimed in claim 1 wherein the first and second alignment devices (9) each include a spacer member (19) for determining the spacing of the respective alignment device (1) relative to an abutment, the spacer member for the first alignment device having a different length to that of the second alignment device.

13. An apparatus as claimed in claim 1, wherein the mounting means (9) includes a substantially cylindrical member (23) for engaging in a support.

14. An apparatus as claimed in claim 13, wherein the length of the substantially cylindrical member (23) for the first alignment device (1) is different to the length of the substantially cylindrical member for the second alignment device.
